(19) United States
(12) Patent Application Publication
(10) Pub. No.: US 2025/0022636 A1
(43) Pub. Date: Jan. 16, 2025

(54) DEVICE UNDER IRRADIATION BEAM AND IRRADIATION PRODUCTION LINE

(71) Applicants: HUAZHONG UNIVERSITY OF SCIENCE & TECHNOLOGY, Wuhan, Hubei (CN); HUAZHONG UNIVERSITY OF SCIENCE AND TECHNOLOGY, Wuhan, Hubei (CN)

(72) Inventors: Jiang HUANG, Wuhan (CN); Taiyan CHEN, Wuhan (CN); Keyan CHENG, Wuhan (CN); Mingwu FAN, Wuhan (CN); Tiaoqin YU, Wuhan (CN)

(21) Appl. No.: 18/713,736

(22) PCT Filed: Nov. 29, 2022
(86) PCT No.: PCT/CN2022/135132

§ 371 Date: May 28, 2024

(30) Foreign Application Priority Data
Nov. 29, 2021 (CN) 202111432988.5

(51) Int. Cl. H01B 19/04; G21K 5/10

(52) U.S. Cl. CPC H01B 19/04; G21K 5/10

(57) ABSTRACT

An irradiation under-beam device (2) and an irradiation processing production line, which belong to the technical field of irradiation processing and are used to improve the irradiation uniformity of an insulator (1) during irradiation processing. The irradiation under-beam device (2) comprises a frame (21), a rotary clamping member (22), and a supporting device (23). The rotary clamping member (22) is configured to secure a first end of the insulator (1), the rotary clamping member (22) is rotatably connected to the frame (21), and when the rotary clamping member (22) clamps the insulator (1), the axis of rotation of the rotary clamping member (22) relative to the frame (21) coincides with the axis of the insulator (1). The supporting device (23) is arranged on the frame (21), and the supporting device (23) is configured to support and secure a second end of the insulator (1). The irradiation under-beam device (2) is used to secure the insulator (1), so that the insulator (1) can receive radiation from a radiation source (4).

### CROSS-REFERENCE TO RELATED APPLICATION

This application claims the priority of the Chinese patent application No. 202111432988.5, entitled “DEVICE UNDER IRRADIATION BEAM AND IRRADIATION PRODUCTION LINE”, and filed on Nov. 29, 2021, the disclosure of which is incorporated herein by reference in its entirety.

### TECHNICAL FIELD

The present disclosure relates to the technical field of irradiation processing, in particular to a device under irradiation beam and an irradiation production line.

### BACKGROUND

An insulator is an insulation member widely used in various high-voltage and low-voltage circuits, and includes a protective sleeve made of silicone rubber. Generally, during a processing for the insulator, it is necessary to irradiate the insulator to improve the hardness and wear resistance of the protective sleeve made of silicone rubber. However, the insulator is of a cylindrical structure, during the insulator is irradiated by irradiation ray from an irradiation source, a portion of a radial side surface of the insulator away from the irradiation source will be sheltered and cannot be irradiated by the irradiation ray sufficiently, which leads to a poor irradiation uniformity of the protective sleeve, and thus mechanical properties of the protective sleeve cannot be improved effectively.

### SUMMARY

Embodiments of the present disclosure provide a device under irradiation beam and an irradiation production line to improve irradiation uniformity for an insulator during an irradiation processing.

The device under irradiation beam in embodiments of the present disclosure is configured to secure the insulator to allow the insulator to be irradiated by an irradiation source. The device under irradiation beam in embodiments of the present disclosure includes a bracket, a rotary clamp and a supporting member. The rotary clamp is configured to clamp a first end of the insulator. The rotary clamp is rotatably connected to the bracket. An axis of rotation of the rotary clamp with respect to the bracket coincides with an axis of the insulator when the insulator is clamped by the rotary clamp. The supporting member is arranged on the bracket and configured to support a second end of the insulator.

In some embodiments of the present disclosure, the bracket includes a bottom frame and a rotary frame. The supporting member is arranged on the bottom frame. The rotary frame is movably connected to the bottom frame, and is rotatable with respect to the bottom frame to adjust an angle between the rotary frame and the bottom frame. When the device under irradiation beam is located at a predetermined position, an irradiation source and the device under irradiation beam are arranged in a first direction. There is an angle between an axis of rotation of the rotary frame with respect to the bottom frame and the first direction. The rotary clamp is rotatably connected to the rotary frame. There is an angle between an axis of rotation of the rotary clamp with respect to the rotary frame and the axis of rotation of the rotary frame with respect to the bottom frame.

In some embodiments of the present disclosure, the bottom frame includes a bottom frame body and a supporting plate. The supporting member is arranged on the bottom frame body. The supporting plate is secured to the bottom frame body. The supporting plate is provided with a first slot. The rotary frame includes a rotary frame body and a rotary shaft which is at least partly located within the first slot. The rotary shaft is rotatable with respect to the first slot around an axis. There is an angle between the axis of the rotary shaft and the first direction. The rotary shaft being secured to the rotary frame body. The rotary clamp is rotatably connected to the rotary frame body. There is an angle between an axis of rotation of the rotary clamp with respect to the rotary frame body and the axis of the rotary shaft.

In some embodiments of the present disclosure, the first slot passes through two opposite sidewalls of the supporting plate. The device under irradiation beam further includes a locking member which extends through two opposite sidewalls of the first slot. The locking member is configured to adjust a spacing between the two opposite sidewalls of the first slot to clamp the rotary shaft by the two opposite sidewalls of the first slot or release the rotary shaft from the two opposite sidewalls of the first slot.

In some embodiments of the present disclosure, there is an angle between the axis of the rotary shaft and an extending direction of the first slot. An inner wall of the first slot is provided with a rotary shaft groove cooperating with the rotary shaft.

In some embodiments of the present disclosure, the supporting plate is provided with scales along a circumference of the rotary shaft groove.

In some embodiments of the present disclosure, the device under irradiation beam further includes a driving member secured to the rotary frame. A driving end of the driving member is rotatably connected to the rotary clamp. The driving member is configured to drive the rotary clamp to rotate with respect to the bracket.

In some embodiments of the present disclosure, the rotary frame has a through hole. The driving end of the driving member extends through the through hole, and the driving end of the driving member is connected with the rotary clamp.

In some embodiments of the present disclosure, wherein the device under irradiation beam further includes a first shielding shell secured to the rotary frame. A cavity with a first opening is formed within the first shielding shell. The through hole is in communication with the cavity through the first opening. The driving member is located within the cavity. The driving end of the driving member extends into the through hole through the first opening.

In some embodiments of the present disclosure, the bracket includes a supporting frame and a shielding plate secured to each other. The shielding plate is perpendicular to the first direction. The device under irradiation beam further includes a driving member controller electrically connected to the driving member. The driving member is arranged on a side of the shielding plate adjacent to the irradiation source. The driving member controller is arranged on a side of the shielding plate away from the irradiation source.

In some embodiments of the present disclosure, the device under irradiation beam further includes a second shielding shell arranged on the side of the shielding plate away from the irradiation source. An accommodation cavity is formed within the second shielding shell. The driving member controller is arranged within the accommodation cavity.

In some embodiments of the present disclosure, the supporting member includes a first translation driving member, a second translation driving member and a support. The first translation driving member is arranged on the bracket. The second translation driving member is secured to a driving end of the first translation driving member. The first translation driving member is configured to drive the second translation driving member to move in a second direction. The support is configured to support the second end of the insulator. The support is secured to a driving end of the second translation driving member. The second translation driving member is configured to drive the supporting member to move in a third direction. There is an angle between the second direction and the third direction. A plane defined by the second direction and the third direction is perpendicular to the axis of rotation of the rotary frame with respect to the bottom frame.

The irradiation production line in embodiments of the present disclosure includes an irradiation chamber, a conveying member and at least one device under irradiation beam according to an embodiment of the present disclosure. The irradiation chamber has an inlet and an outlet. The irradiation source is arranged within the irradiation chamber. The device under irradiation beam is arranged within the irradiation chamber. The conveying member is configured to convey the device under irradiation beam from the inlet towards the outlet. During a travel of the device under irradiation beam, the device under irradiation beam is located at the predetermined position when the device under irradiation beam is at a minimum distance from the irradiation source.

By means of the device under irradiation beam in embodiments of the present disclosure, an operator may rotate the rotary clamp with respect to the bracket, such that the insulator secured to the rotary clamp can be rotated around the axis. During the rotation of the insulator around the axis, a portion of a radial side surface of the insulator away from the irradiation source will gradually approach the irradiation source, such that no portion of the radial side surface of the insulator will be consistently sheltered, which enables an uniform irradiation of the radial side surface of the insulator.

### BRIEF DESCRIPTION OF THE DRAWINGS

In order to more clearly illustrate specific implementations of the present disclosure or technical solutions in the related art, Figures used in the description of the specific implementations or the related art will be briefly described below. Obviously, the Figures described below are merely some of the implementations of the present disclosure, and other Figures can be obtained according to these drawings for those skilled in the art without creative labor.

FIG. 1 is a schematic view of an insulator in an embodiment of the present disclosure;

FIG. 2 is a schematic view of an irradiation production line in an embodiment of the present disclosure;

FIG. 3 is a schematic view of the insulator secured to a device under irradiation beam in an embodiment of the present disclosure;

FIG. 4 is a schematic view of the device under irradiation beam in an embodiment of the present disclosure;

FIG. 5 is a partially enlarged view of portion A in FIG. 4;

FIG. 6 is a partially enlarged view of portion B in FIG. 5;

FIG. 7 is an explosive view of the assembling of an electric motor and a rotary clamp in an embodiment of the present disclosure seen from a first angle of view;

FIG. 8 is an explosive view of the assembling of the electric motor and the rotary clamp in an embodiment of the present disclosure seen from a second angle of view;

FIG. 9 is a schematic view of an rotary frame in an embodiment of the present disclosure seen from a first angle of view;

FIG. 10 is a schematic view of the rotary frame in an embodiment of the present disclosure seen from a second angle of view;

FIG. 11 is a schematic view of a driving member controller and a driving member power which are arranged in a second shielding shell in an embodiment of the present disclosure;

FIG. 12 is a partially enlarged view of portion C in FIG. 4.

### LIST OF REFERENCE SYMBOLS

1—insulator; 11—skirt; 2—device under irradiation beam; 21—bracket; 211—bottom frame; 2111—bottom frame body; 21111—Supporting frame; 21112—shielding plate; 2112—supporting plate; 21121—first slot; 21122—rotary shaft groove; 21123—scales; 2113—locking piece; 2114—auxiliary supporting plate; 21131—extending hole; 2115—first connection plate; 212—rotary frame; 2121—rotary frame body; 2122—rotary shaft; 21221—second slot; 2123—through hole; 2124—bearing; 2125—auxiliary rotary shaft; 2126—fixing plate; 21261—shaft hole; 22—rotary clamp; 221—connection shaft; 222—coupler; 23—supporting member; 231—first translation driving member; 2311—driving end of the first translation driving member; 232—second translation driving member; 2321—driving end of the second translation driving member; 2322—base of second translation driving member; 233—support; 234—right-angle trapezoidal plate; 2341—lightening hole; 235—second connection plate; 24—driving member; 25—first shielding shell; 251—cavity; 2511—first opening; 26—driving member controller; 27—driving member power; 28—second shielding shell; 3—conveying member; 4—irradiation source; 41—irradiation ray; a—first direction; b—second direction; c—predetermined position.

### DETAILED DESCRIPTION

Technical solutions of embodiments of the present disclosure will be clearly and sufficiently described in conjunction with the drawings hereinafter. It is obvious that the embodiments recited below are merely a part of the embodiments of the present disclosure, but not all of the embodiments of the present disclosure. Based on the embodiments of the present disclosure, other embodiments obtained by those skilled in the art without creative labor still fall within the protection scope of the present disclosure.

It should be noted that in the description of the present disclosure, terms describing orientations or position relationships, such as “center”, “upward”, “downward”, “left”, “right”, “vertical”, “horizontal”, “inner”, “outer” and the like, are based on the orientations or position relationships shown in the Figures, merely for ease of describing the present disclosure and simplifying the description, and are not intended to indicate or imply that devices or elements referred to must have specific orientations or must be configured or operated in specific orientations. Therefore theses terms should not be understood as limiting to the present disclosure.

It should be noted that in the description of the present disclosure, terms describing orientations or position relationships, such as “center”, “upward”, “downward”, “left”, “right”, “vertical”, “horizontal”, “inner”, “outer” and the like, are based on the orientations or position relationships shown in the Figures, merely for ease of describing the present disclosure and simplifying the description, and are not intended to indicate or imply that devices or elements referred to must have specific orientations or must be configured or operated in specific orientations. Therefore theses terms should not be understood as limiting to the present disclosure. For those skilled in the art, specific meanings of the terms mentioned above in the embodiments of the present disclosure can be understood according to specific circumstances.

Furthermore, technical features involved in different embodiments of the present disclosure described below may be combined as long as they do not conflict with each other.

Anti-pollution flashover of external insulation equipment in a power system is an important technology which is associated with the safe operation of equipment in the power system. Various filths such as smoke dust and powder in the atmosphere inevitably fall on external insulation surfaces of electric transmission and transformation equipment. The more serious the air pollution, the more filths accumulated on the insulator, and thus pollution flashover discharge is more likely to occur. At present, the insulator has been widely used in all kinds of electric transmission wires, which effectively improves pollution flashover voltages and wet flashover voltages of these electric transmission and transformation wires, and ensures the normal operation of these wires.

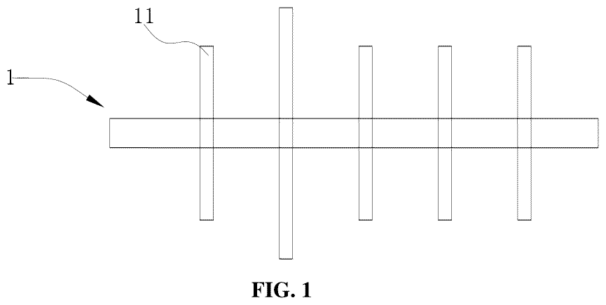

With reference to FIG. 1, the insulator 1 is of a cylindrical structure, and includes a protective sleeve made of silicone rubber. The protective sleeve is provided with a plurality of skirts 11 extending radially outward. The plurality of skirts 11 are arranged along an axial direction of the insulator 1. The protective sleeve is configured to perform a protection and insulation function. However, the insulator 1 is hung on the high-voltage wire tower during operation, and tends to be affected by bird pecking, strong wind and so on. The protective sleeve often cannot achieve an effective protection effect in this harsh environment. Under the strong wind, the insulator 1 is prone to swing periodically, which eventually result in a fatigue fracture.

In the related art, in order to reduce damages to the insulator, the insulator generally undergoes an irradiation processing to improve a cross-linking density of the protective sleeve made of silicone rubber, thereby improving the hardness and wear resistance of the silicone rubber. However, since the insulator is of a cylindrical structure, during an irradiation source emits irradiation ray towards the insulator, a portion of a radial side surface of the insulator away from the irradiation source will be sheltered and cannot be irradiated by the irradiation ray sufficiently, which leads to a poor irradiation uniformity for the protective sleeve. Thus mechanical properties of the protective sleeve cannot be improved effectively.

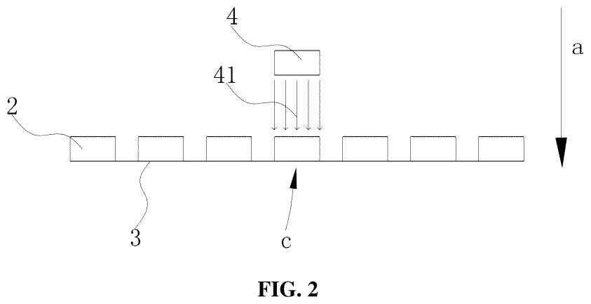

With reference to FIG. 2, an embodiment of the present disclosure provides an irradiation production line including at least one device under irradiation beam 2, an irradiation chamber and a conveying member 3. The irradiation chamber includes an inlet and an outlet. The irradiation source 4 is arranged within the irradiation chamber. The device under irradiation beam 2 is arranged within the irradiation chamber. The conveying member 3 is configured to convey the device under irradiation beam 2 from the inlet towards the outlet. During a travel of the device under irradiation beam 2, the device under irradiation beam 2 is located at the predetermined position c when the device under irradiation beam 2 is at a minimum distance from the irradiation source 4. In this way, the device under irradiation beam 2 is configured to secure the insulator 1, and the conveying member 3 is configured to convey the device under irradiation beam 2 in the irradiation chamber, so as to allow the insulator 1 to be irradiated by irradiation ray 41 emitted from the irradiation source 4. There may be a plurality of devices under irradiation beam 2. Each device under irradiation beam 2 is configured to secure the insulator 1. The conveying member 3 is configured to drive the insulators 1 to pass the predetermined position c successively. The conveying member 3 may be a belt conveying mechanism, a chain conveying mechanism, or the like.

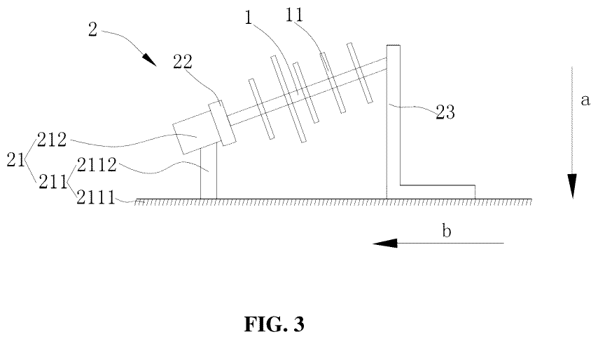

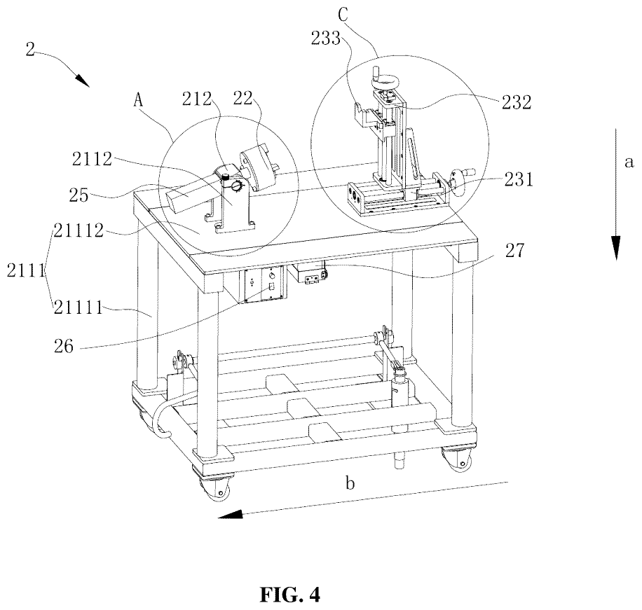

An embodiment of the present disclosure provides a device under irradiation beam 2 with reference to FIG. 3 and FIG. 4. The device under irradiation beam 2 is configured to secure the insulator 1 so as to allow the insulator 1 to be irradiated by the irradiation source 4. The device under irradiation beam 2 includes a bracket 21, a rotary clamp 22 and a supporting member 23. The rotary clamp 22 is configured to secure a first end of the insulator 1. The rotary clamp 22 is rotatably connected to the bracket 21. An axis of rotation of the rotary clamp 22 with respect to the bracket 21 coincides with an axis of the insulator 1 when the insulator 1 is clamped by the rotary clamp 22. The supporting member 23 is arranged on the bracket 21 and configured to support and secure a second end of the insulator 1. In this way, an operator can drive the rotary clamp 22 to rotate with respect to the bracket 21, such that the insulator 1 secured on the rotary clamp is driven by the rotary clamp 22 to rotate around the axis. During the rotation of the insulator 1 around the axis, the portion of the radial side surface of the insulator 1 away from the irradiation source 4 will gradually approach the irradiation source 4, such that no portion of the radial side surface of the insulator 1 will be consistently sheltered by other portions, which results in an uniform irradiation for the radial side surface of the insulator 1. In addition, the first end of the insulator 1 is secured to the rotary clamp 22, while the supporting member supports the second end of the insulator 1. Since the insulator 1 is supported by the supporting member, a better securing function of the device under irradiation beam 2 for the insulator 1 can be achieved. Moreover, the supporting member will not limit the rotation of the insulator 1 around the axis when the insulator 1 is driven by the rotary clamp 22 to rotate around the axis.

It should be noted that the smaller a variation in an irradiation dose for the insulator 1 in a circumferential direction, the higher the irradiation uniformity for the radial side surface of the insulator 1. The irradiation dose refers to a quantity of radiant energy of the radiation 41 received by per unit mass of substance.

In some embodiments, the rotary clamp 22 may be a chuck. The chuck may be a two-jaw chuck, a three-jaw chuck, a four-jaw chuck, a six-jaw chuck or a special chuck. In an embodiment of the present disclosure, the rotary clamp 22 is a three-jaw chuck.

In some embodiments, with reference to FIG. 3 and FIG. 4, the bracket 21 includes a bottom frame 211 and a rotary frame 212. The supporting member is arranged on the bottom frame 211. The rotary frame 212 is movably connected to the bottom frame 211. The rotary frame 212 is rotatable with respect to the bottom frame 211 to adjust an angle between the rotary frame and the bottom frame 211. When the device under irradiation beam 2 is located at the predetermined position c, the irradiation source 4 and the device under irradiation beam 2 are arranged in a first direction a. There is an angle between an axis of rotation of the rotary frame 212 with respect to the bottom frame 211 and the first direction a. The rotary clamp 22 is rotatably connected to the rotary frame 212. There is an angle between an axis of rotation of the rotary clamp 22 with respect to the rotary frame 212 and the axis of rotation of the rotary frame 212 with respect to the bottom frame 211. In this way, an angle between the axis of the insulator 1 and a reference plane (a plane perpendicular to the first direction a) is variable during the rotation of the rotary frame 212 with respect to the bottom frame 211. The operator may adaptively adjust the angle between the axis of the insulator 1 and the reference plane according to a size of the skirt 11. On the one hand, by form an angle between the skirt 11 and the first direction a, a greater contact area between the skirt 11 and the radiation 41 can be achieved. On the other hand, by form the angle, the area of the portion of the skirt 11 away from the irradiation source 4 sheltered in the first direction by the portion of the skirt 11 adjacent to the irradiation source 4 is smaller.

It should be understood that if the axis of the insulator 1 is parallel to the first direction a, the portion of the skirt 11 adjacent to the irradiation source 4 will shelter in the first direction a larger area of the portion of the skirt 11 away from the irradiation source 4, therefore the portion of the skirt 11 away from the irradiation source 4 cannot be irradiated sufficiently. If the axis of the insulator 1 is perpendicular to the first direction a and the skirt 11 is parallel to the first direction a, the contact area between the skirt 11 and the irradiation ray 41 is smaller, thus the skirt 11 cannot be irradiated sufficiently. The expression “the skirt 11 is parallel to the first direction a” means that an extending direction of the skirt 11 is parallel to the first direction a. The extending direction of the skirt 11 is radially outward from the insulator 1, i.e., perpendicular to the axis of the insulator 1.

It should be noted that the irradiation ray 41 may refer to X-ray, γ-ray or high-energy electron beam ray etc. emitted by the irradiation source 4. In an embodiment of the present disclosure, the irradiation source 4 is an electron beam irradiation source 4, and the irradiation ray 41 is high-energy electron beam ray. In this case, in some embodiments, the energy of the electron beam is 5 MeV.

It should be noted that the expression “there is an angle between the axis of rotation of the rotary frame 212 with respect to the bottom frame 211 and the first direction a” means that the angle between the axis of rotation of the rotary frame 212 with respect to bottom frame 211 and the first direction a is greater than zero degree. The same applies to the expression “there being an angle between the axis of rotation of the rotary clamp 22 with respect to the rotary frame 212 and the axis of rotation of the rotary frame 212 with respect to the bottom frame 211”.

In some embodiments, with reference to FIG. 3 and FIG. 4, the axis of rotation of the rotary frame 212 with respect to the bottom frame 211 is perpendicular to the first direction a. In this way, compared with a situation in which the angle between the axis of rotation of the rotary frame 212 with respect to the bottom frame 211 and the first direction a is another angle, the rotary frame 212 is able to drive the insulator 1 to rotate by a larger angle with respect to the reference plane, for the same rotation angle of the rotary frame 212 with respect to the bottom frame 211, which is beneficial to improving work efficiency. On the basis that the axis of rotation of the rotary frame 212 with respect to the bottom frame 211 is perpendicular to the first direction a, in some embodiments, with reference to FIG. 3 and FIG. 4, the axis of rotation of the rotary clamp 22 with respect to the rotary frame 212 is perpendicular to the axis of rotation of the rotary frame 212 with respect to the bottom frame 211. In this way, the insulator 1 is able to rotate in a larger rotation angle range with respect to the reference plane, and the operator can make a flexible choice according to the actual situation.

The angle between the axis of rotation of the rotary clamp 22 with respect to the rotary frame 212 and the axis of rotation of the rotary frame 212 with respect to the bottom frame 211 is referred to as a predetermined angle. It should be understood that in the case that the axis of rotation of the rotary frame 212 with respect to the bottom frame 211 is perpendicular to the first direction a, the predetermined angle is less than or equal to 90 degrees, and a rotation angle of the insulator 1 with respect to the reference plane is greater than zero degree and less than the predetermined angle.

Generally, in some embodiments, with reference to FIG. 2, the irradiation source 4 is arranged above the device under irradiation beam 2, and the first direction a is in the vertical direction, that is, when the device under irradiation beam 2 is located in a target position, the irradiation source 4 is located directly above the device under irradiation beam 2, and the axis of rotation of the rotary frame 212 with respect to the bottom frame 211 is horizontal.

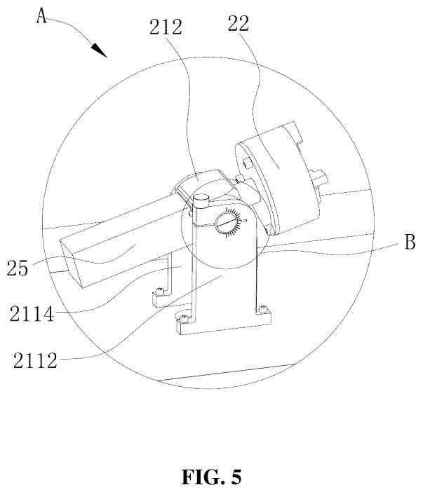

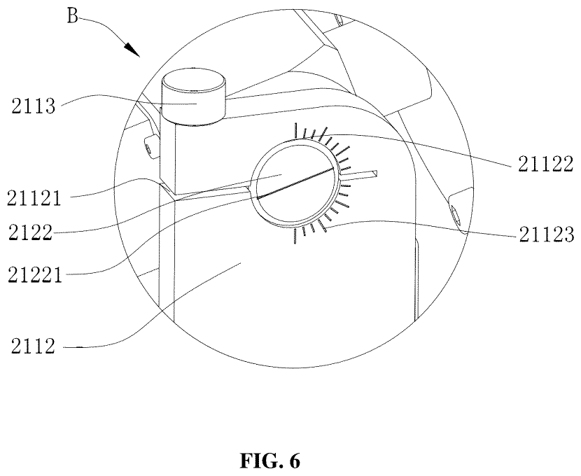

In some embodiments, with reference FIG. 4, FIG. 5 and FIG. 6, FIG. 5 is a partially enlarged view of area A in FIG. 4, and FIG. 6 is a partially enlarged view of area B in FIG. 5. The bottom frame 211 includes a bottom frame body 2111 and a supporting plate 2112. The supporting member 23 is arranged on the bottom frame body 2111. The supporting plate 2112 is secured to the bottom frame body 2111. The supporting plate 2112 is provided with a first slot 21121. The rotary frame 212 includes a rotary frame body 2121 and a rotary shaft 2122 which is at least partly located within the first slot 21121. The rotary shaft 2122 is rotatable with respect to the first slot 21121 around an axis. There is an angle between the axis of the rotary shaft 2122 and the first direction a. The rotary shaft 2122 is secured to the rotary frame body 2121. The rotary clamp 22 is rotatably connected to the rotary frame body 2121. There is an angle between an axis of rotation of the rotary clamp 22 with respect to the rotary frame body 2121 and the axis of the rotary shaft 2122. In this way, the rotary shaft 2122 is inserted in the first slot 21121, which enables a relative rotation between the rotary frame 212 and the bottom frame 211. It should be understood that the axis of the rotary shaft 2122 is also the axis of rotation of the rotary frame 212 with respect to the bottom frame 211, and that a rotation of the rotary shaft 2122 around the axis of the rotary shaft in the first slot 21121 means that the rotary frame 212 rotates with respect to the bottom frame 211.

In some embodiments, the first slot 21121 passes through two opposite sidewalls of the supporting plate 2112, the device under irradiation beam 2 further includes a locking member 2113 which extends through two opposite sidewalls of the first slot 21121, and the locking member 2113 is configured to adjust a spacing between the two opposite sidewalls of the first slot 21121 to clamp the rotary shaft 2122 by the two opposite sidewalls of the first slot 21121 or release the rotary shaft from the two opposite sidewalls of the first slot. In this way, since the rotary shaft 2122 extends through the first slot 21121, when the locking member 2113 is in a locking state, the spacing between the two opposite sidewalls of the first slot 21121 is small, and the two opposite sidewalls of the first slot 21121 clamp the rotary shaft 2122, thus a relative position of the rotary shaft 2122 with respect to the supporting plate 2112 is fixed. When the locking member 2113 is in a unlocking state, the spacing between the two opposite sidewalls of the first slot 21121 is large, and the two opposite sidewalls of the first slot 21121 release the rotary shaft 2122, thus the rotary shaft 2122 can rotate around the axis of the rotary shaft. When the locking member 2113 is in the unlocking state, the operator may rotate the rotary frame 212 with respect to the bottom frame 211 so as to adjust the rotary frame 212 to reach an appropriate position. After the rotary frame 212 has been adjusted to the appropriate position, the operator may lock the locking member 2113 such that the rotary frame 212 is fixed with respect to the bottom frame 211.

In some embodiments, the locking member 2113 is a screw which extends through the two opposite sidewalls of the first slot 21121. In some embodiments, the locking member 2113 is a knurled thumbscrew. The knurled thumbscrew is a kind of screw that can be easily operated by hand. A head of the knurled thumbscrew is provided with axial texture, which are used to increase a friction between the hand and the knurled thumbscrew during screwing. In this way, the operator is able to adjust the angle between the rotary frame 212 and the bottom frame 211 without using additional tools, which is beneficial to improving work efficiency.

With reference to FIG. 4, FIG. 5 and FIG. 6, generally, the first direction a is the vertical direction, the supporting plate 2112 extends in the vertical direction, the supporting plate 2112 is located above the bottom frame body 2111, and an inner wall of the first slot 21121 is perpendicular to a surface of the supporting plate 2112. In this way, the axis of the rotary shaft 2122 inserted in the first slot 21121 is parallel to the horizontal direction, that is, the axis of rotation of the rotary frame 212 with respect to the bottom frame 211 is horizontal. In this case, an extending direction of the first slot 21121 is in the horizontal direction. In this way, the first slot 21121 has a better supporting effect for the rotary shaft 2122, such that the rotary shaft 2122 is inserted in the first slot 21121 firmly. It should be noted that the extending direction of the first slot 21121 is a direction from a first opening 2511 of the first slot 21121 to an interior of the first slot 21121. The extending direction of the first slot 21121 is perpendicular to a thickness direction of the supporting plate 2112.

In order to ensure a reliable assembly between the rotary shaft 2122 and the supporting plate 2112, in some embodiments, with reference to FIG. 4, FIG. 5 and FIG. 6, there is an angle between the axis of the rotary shaft 2122 and the extending direction of the first slot 21121, and an inner wall of the first slot 21121 is provided with a rotary shaft groove 21122 cooperating with the rotary shaft 2122. In this way, the assembly between the rotary shaft 2122 and the supporting plate 2112 is more reliable. Generally, both the rotary shaft 2122 and the rotary shaft groove 21122 are circular in shape. In this way, the rotary shaft 2122 is able to rotate stably around the axis. In some embodiments, the axis of the rotary shaft 2122 is perpendicular to the extending direction of the first slot 21121, which is beneficial to improving an assembling reliability between the rotary shaft 2122 and the supporting plate 2112.

In order to allow the operator to adjust the angle between the rotary frame 212 and the bottom frame 211 more precisely, in some embodiments with reference to FIG. 4, FIG. 5 and FIG. 6, the supporting plate 2112 is provided with scales along a circumference of the rotary shaft groove 21122. In some embodiments, with reference to FIG. 4, FIG. 5, and FIG. 6, an end surface of an end of the rotary shaft 2122 which is inserted in the first slot is provided with a second slot 21221 radially passing through a circle center of a cross section of the rotary shaft 2122. In this way, when the rotary shaft 2122 rotates around its axis, the end of the second slot 21221 also rotates along a circumference of the rotary shaft groove 21122 by a rotation angle which is the same as the rotation angle of the rotary shaft 2122. The operator may determine the rotation angle of the rotary shaft 2122 based on the relative position relationships between the end of the second slot 21221 and the scales 21123, thereby determining the angle between the rotary frame 212 and the bottom frame 211.

In some embodiments, with reference to FIG. 4, FIG. 5, and FIG. 6, the bottom frame 211 further includes an auxiliary supporting plate 2114 which is arranged on the bottom frame body 2111. The supporting plate 2112 and the auxiliary supporting plate 2114 are arranged along an axial direction of the rotary shaft 2122. The rotary frame 212 further includes an auxiliary rotary shaft 2125. The auxiliary rotary shaft 2125 and the rotary shaft 2122 are arranged on two sides of the rotary frame body 2121 in the axial direction of the rotary shaft 2122. An axis of the auxiliary rotary shaft 2125 coincides with the axis of the rotary shaft 2122. The auxiliary supporting plate 2114 is provided with a extending hole 21131 cooperating with the auxiliary rotary shaft 2125. The auxiliary rotary shaft 2125 extends through the extending hole 21131. In this way, the supporting plate 2112 and the auxiliary supporting plate 2114 support the rotary frame 212 on two sides of the rotary frame 212, which enables a more reliable assembly between the rotary frame 212 and the bottom frame 211.

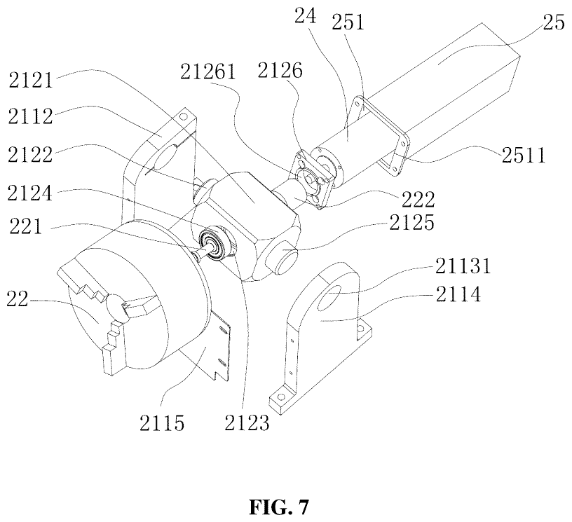

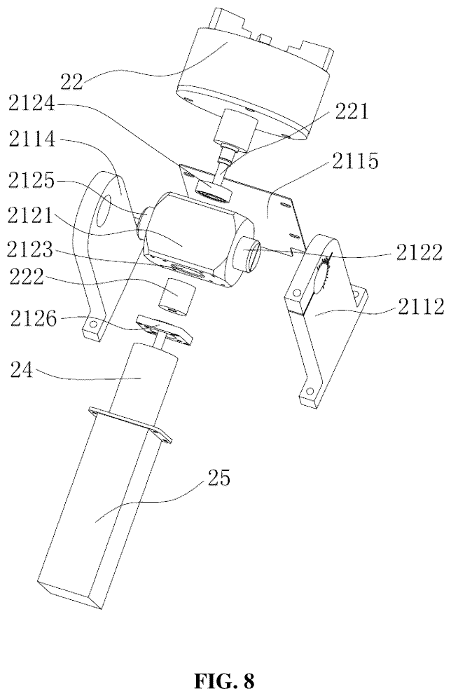

In order to improve the stress condition of the supporting plate 2112 and the auxiliary supporting plate 2114, in some embodiments, with reference to FIG. 7 and FIG. 8, the bottom frame 211 further includes a first connection plate 2115 arranged on the bottom frame body 2111. The auxiliary supporting plate 2114 and the supporting plate 2112 are both connected to the first connection plate 2115. In this way, a stability of the connection between the bottom frame body 2111 and the supporting plate 2112 as well as the auxiliary supporting plate 2114 can be enhanced.

In some embodiments, with reference to FIG. 7 and FIG. 8, the device under irradiation beam 2 further includes a driving member 24 secured to the rotary frame 212, a driving end of the driving member 24 is rotatably connected to the rotary clamp 22, and the driving member 24 is configured to drive the rotary clamp 22 to rotate with respect to the bracket 21.

In some embodiments, with reference to FIG. 7 and FIG. 8, the rotary frame 212 has a through hole 2123, the driving end of the driving member 24 extends through the through hole 2123, and the driving end of the driving member is connected with the rotary clamp 22, which enables a more reliable assembly between the driving member 24, the rotary clamp 22 and the rotary frame 212. In order to support and protect the driving member 24, in some embodiments, the device under irradiation beam 2 further includes a first shielding shell 25 secured to the rotary frame 212, a cavity 251 with a first opening 2511 is formed within the first shielding shell 25, the through hole 2123 is in communication with the cavity 251 through the first opening 2511, the driving member 24 is located within the cavity 251, and the driving end of the driving member 24 extends into the through hole 2323 through the first opening 2511.

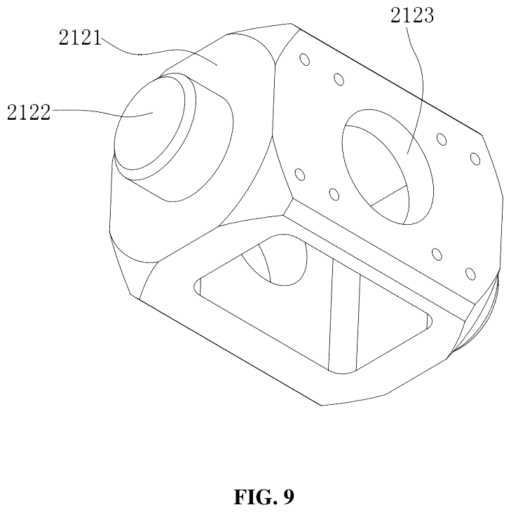

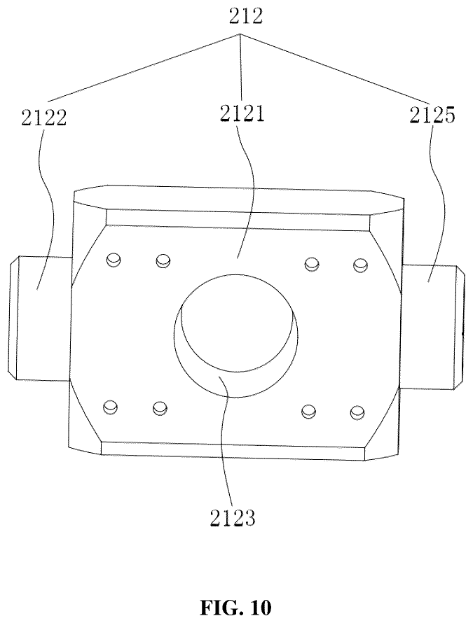

In some embodiments, with reference to FIG. 9 and FIG. 10, the rotary frame 212 is a hollow shell structure, and the through hole 2123 passes through two opposite sidewalls of the rotary frame 212. In this way, material can be saved, a load on the supporting plate 2112 can be reduced, and it is convenient for the operator to rotate the rotary frame 212.

Generally, with reference to FIG. 7 and FIG. 8, the driving member 24 is an electric motor, a driving shaft of which extends through the through hole 2123 and is connected to the rotary clamp 22. The electric motor can be connected to the rotary frame 212 via a fixing plate 2126. An end cover of the electric motor is connected to the fixing plate 2126 via screws. The fixing plate 2126 is connected to the rotary frame 212 via screws. The fixing plate 2126 is provided with a shaft hole 21261, through which the driving shaft extends into the through hole 2123. In this way, the electric motor can be reliably connected to the rotary frame 212.

During assembly of the electric motor and the rotary clamp, firstly the fixing plate 2126 is assembled on the electric motor, next the driving shaft of the electric motor is arranged to extend through the through hole 2123, then the driving shaft of the electric motor is connected to the rotary clamp 22, then the fixing plate 2126 is secured to the rotary frame 212 via the screws, finally the driving member 24 is arranged to extend into the first shielding shell 25, and the first shielding shell 25 is secured to the rotary frame 212.

In some embodiments, with reference to FIG. 7 and FIG. 8, a distal end of the rotary clamp 22 is provided with a connection shaft 221, an axis of which coincides with an axis of the driving shaft of the electric motor. The driving shaft of the electric motor is connected to the connection shaft 221 via a coupler 222. A bearing 2124 is arranged at an end of the through hole 2123 adjacent to the rotary clamp 22. The connection shaft 221 passes through the bearing 2124. In this way, the through hole 2123 may support the connection shaft 221 by means of the bearing 2124, and in turn support the rotary clamp 22, to realize a more stable connecting between the rotary clamp 22 and the electric motor.

In some embodiments, with reference to FIG. 4, the bracket 21 includes a supporting frame 21111 and a shielding plate 21112 secured to each other. The shielding plate 21112 is perpendicular to the first direction a. The device under irradiation beam 2 further includes a driving member controller 26 electrically connected to the driving member 24, the driving member 24 is arranged on a side of the shielding plate 21112 adjacent to the irradiation source 4. The controller of the driving member 24 is arranged on a side of the shielding plate 21112 away from the irradiation source 4. In this way, the shielding plate can shield the irradiation ray 41 emitted by the irradiation source 4 and reduce an interference of the irradiation ray 41 on the driving member controller 26. In addition, the driving member controller 26 is arranged on the bracket 21 and can be conveyed by the conveying member 3 to move with the driving member 24, such that a long connecting wire between the conveying member 3 and the driving member 24 is avoided. It should be understood that if the driving member controller 26 is secured to the floor, since the device under irradiation beam 2 will be moved due to conveying of the conveying member 3, it is necessary to provide a longer connecting wire between the driving member 24 and the driving member controller 26. In some embodiments, the device under irradiation beam 2 further includes a driving member power 27 which is electrically connected to the driving member controller 26 and arranged on the side of the shielding plate 21112 away from the irradiation source 4. In this way, the shielding plate 21112 can protect the driving member power 27 and reduce interference of the irradiation ray 41 on the driving member power.

It should be noted that in an embodiment of the present disclosure, with reference to FIG. 4, the supporting frame 21111 and the shielding plate 21112 are parts of the bottom frame body 2111, that is, the bracket includes the bottom frame 211 and the rotary frame 212, the bottom frame 211 includes the bottom frame body 2111 and the supporting plate 2112, and the bottom frame body 2111 includes the supporting frame 21111 and the shielding plate 21112.

In some embodiments, the conveying member 3 is located on the side of the shielding plate 21112 away from the irradiation source 4. In this way, the shielding plate 21112 can protect the conveying member 3 and reduce interference of the irradiation ray 41 on the conveying member. A volume of the conveying member 3 is relatively large, thus it is not unrealistic to provide a shell for protecting the conveying member. In this case, the shielding plate 21112 may protect the conveying member.

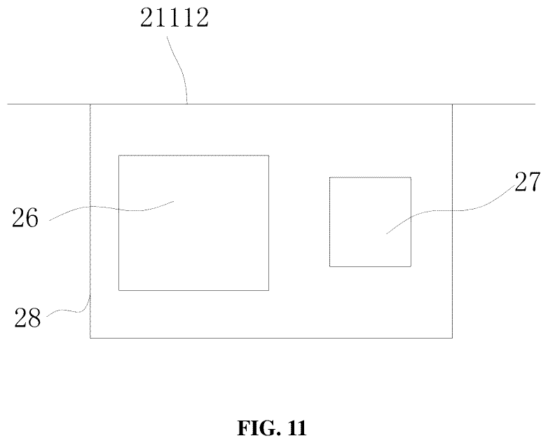

In some embodiments, with reference to FIG. 11, the device under irradiation beam 2 further includes a second shielding shell 28 arranged on the side of the shielding plate 21112 away from the irradiation source 4. An accommodation cavity is formed within the second shielding shell 28. The driving member controller 26 is arranged within the accommodation cavity. In this way, the second shielding shell 28 can reduce interference of the irradiation ray 41 on the driving member controller 26. In some embodiments, both the driving member controller 26 and the driving member power 27 are located within the second shielding shell 28.

In some embodiments, the second shielding shell 28 is provided with a second opening, which is covered by a shielding cover plate. The shielding cover plate is detachably connected to the second shielding shell 28. In this way, the operator may remove the shielding cover plate to perform operations, such as the operations of replacing the driving member power 27 or turning on/off a switch of the driving member controller 26.

In some embodiments, the second shielding shell 28 includes a first shielding layer and a second shielding layer. The second shielding layer is arranged on an outside the first shielding layer, and an atomic number of a material of the first shielding layer is greater than that of the second shielding layer. In some embodiments, the material of the first shielding layer is plumbum, while the material of the second shielding layer is steel or aluminum. If the shielding shell is subjected to electron radiation, the bremsstrahlung radiation may occur and γ rays may be generated, which will affect the driving member controller and the driving member power. The second shielding layer is arranged outside the first shielding layer which is configured to shield γ rays generated by the second shielding layer. Since the atomic number of the material of the first shielding layer is greater than that of the second shielding layer, the first shielding layer possesses a better shielding effect for the γ rays. Compared to a solution which does not include the first shielding layer and is intended to shield the γ rays by increasing the thickness of the second shielding layer, a combination of the first shielding layer and the second shielding layer is able to realize a lighter mass of the second shielding shell 28. It should be noted that a material with a larger atomic number possesses a better ability to shield γ rays, but also emits more γ rays when subjected to electron radiation. Therefore, the first shielding layer is arranged on an inner side of the second shielding layer. If the second shielding shell 28 merely includes the first shielding layer and does not include the second shielding layer, that is, if the electron radiation and the γ rays generated by the bremsstrahlung radiation are entirely shield by only the first shielding layer, a larger thickness of the first shielding layer is required, and the second shielding shell 28 will be too heavy.

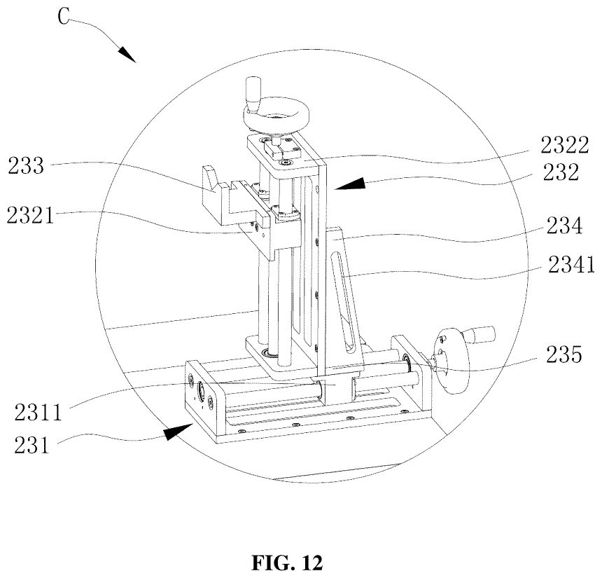

The operator can reasonably set the thickness of the second shielding layer according to a dose of the electron radiation, such that the second shielding layer may completely absorb the electron radiation, and the radiation of electrons onto the first shielding layer is avoided. In some embodiments, the energy of the electron beam is 5 MeV, and the first shielding layer is made of plumbum with a thickness of 3 mm. The second shielding layer is made of aluminum with a thickness of 12 mm. Further, in order to absorb secondary electrons and low-energy γ rays, and to avoid plumbism as much as possible, in some embodiments, the second shielding shell 28 further includes a third shielding layer provided on an inner side of the first shielding layer, and an atomic number of a material of the third shielding layer is greater than that of the first shielding layer. In some embodiments, both the second shielding layer and the third shielding layer are made of steel, and the first shielding layer is made of plumbum. In some other embodiments, both the second shielding layer and the third shielding layer are made of aluminum, and the first shielding layer is made of plumbum. In some embodiments, with reference to FIG. 4 and FIG. 12, the supporting member includes a first translation driving member 231, a second translation driving member 232 and a support 233. The first translation driving member 231 is arranged on the bracket 21. The second translation driving member 232 is secured to a driving end 2311 of the first translation driving member, and the first translation driving member 231 is configured to drive the second translation driving member 232 to move in a second direction b. The support 233 is configured to support the second end of the insulator 1, the support 233 is secured to a driving end 2321 of the second translation driving member, and the second translation driving member 232 is configured to drive the supporting member 233 to move in a third direction (in an optional embodiment, the third direction is the first direction denoted by “a” in the Figures). There is an angle between the second direction b and the third direction. A plane defined by the second direction b and the third direction is perpendicular to the axis of rotation of the rotary frame 212 with respect to the bottom frame 211. There is an angle between the second direction b and the third direction. A plane defined by the second direction b and the third direction is perpendicular to the axis of rotation of the rotary frame 212 with respect to the bottom frame 211. In this way, the first translation member and the second translation member can drive the support 233 to move in a plane perpendicular to the axis of rotation of the rotary frame 212 with respect to the bottom frame 211. When the rotary frame 212 rotates with respect to the bottom frame 211, the second end of the insulator 1 also moves in a plane perpendicular to the axis of rotation of the rotary frame 212 with respect to the bottom frame 211. In this case, the operator may adjust a position of the support 233 accordingly such that the support 233 supports the second end of the insulator 1.

It should be understood that with reference to FIG. 4 and FIG. 12, in a case that the axis of rotation of the rotary clamp 22 with respect to the rotary frame 212 is perpendicular to the axis of rotation of the rotary frame 212 with respect to the bottom frame 211, this supporting member may be used to support the second ends of insulators 1 of different lengths. Since the axis of rotation of the rotary clamp 22 with respect to the rotary frame 212 is perpendicular to the axis of rotation of the rotary frame 212 with respect to the bottom frame 211, a plane in which the second ends of the insulators 1 of different lengths are located is perpendicular to the axis of rotation of the rotary frame 212 with respect to the bottom frame 211 when the rotary clamp 22 is use to clamp insulators 1 of different lengths.

Generally, with reference to FIG. 4 and FIG. 12, the second direction b is perpendicular to the third direction. In this way, a range of movement of the clamping member is relatively larger. In some embodiments, one of the second direction b and the third direction is parallel to the first direction a. In this way, the range of movement of the clamping member can be increased, and the operator may flexibly adjust the position of the clamping member according to the length of the insulator 1 and the angle of the rotary frame 212 with respect to the bottom frame 211.

In one example, the first direction a is the vertical direction, With reference to FIG. 4 and FIG. 12, generally, the second direction b is the horizontal direction, and the third direction is the same as the first direction a, that is, both the third direction and the first direction as are the vertical direction. In this way, a better stress condition at a connection between the first translation driving member 231 and the second translation driving member 232 can be achieved, leading to a higher reliability. It should be understood that if the second direction b is in the vertical direction, the third direction is in the horizontal direction, and the second translation driving mechanism is in the form of a cantilever structure, a relatively poor stress condition at the connection between the first translation driving member 231 and the second translation driving member 232 may be obtained.

In one example, the first direction a is the vertical direction, in some embodiments, with reference to FIG. 3, FIG. 4 and FIG. 12, the support 233 is higher than the rotary clamp 22. In this way, the insulator 1 is more firmly secured to the device under irradiation beam 2 compared to a device under irradiation beam 2 in which the support 233 is lower than the rotary clamp 22.

The first translation driving member 231 and the second translation driving member 232 may be implemented in various forms. For example, the first translation driving member 231 and/or the second translation driving member 232 may be a ball screw mechanism, a rack-and-pinion mechanism, a worm-and-worm-wheel mechanism, a conveying belt mechanism, a linear electric motor, a cylinder or the like. On this basis, in some embodiments, the first translation driving member 231 and/or the second translation driving member 232 may be a sliding table module which may be a lead screw sliding table, a rack-and-pinion sliding table, a worm-and-worm-wheel sliding table, a belt sliding table or the like. The sliding table module can be driven by an electric motor or be driven manually. In an embodiment of the present disclosure, with reference to FIG. 4 and FIG. 12, each of the first translation driving member 231 and the second translation driving member 232 is a manually driven lead screw sliding table.

In the case that the second direction b is perpendicular to the third direction, in some embodiments, with reference to FIG. 4 and FIG. 12, a right-angle trapezoidal plate 234 is provided between a base 2322 of the second translation driving member and the driving end of the first translation driving member 231. A leg of the right-angle trapezoidal plate 234 is connected to the base 2322 of the second translation driving member, and a lower base of the right-angle trapezoidal plate 234 is connected to the driving end of the first translation driving member 231. In this way, a firm connection between the first translation driving member 231 and the second translation driving member 232 can be achieved. In some other embodiments, the base 2322 of the second translation driving member may be connected to the driving end of the first translation driving member 231 by means of a isosceles right triangle plate, a right-angle side of which is connected to the base 2322 of the second translation driving member, and another right-angle side of which is connected to the driving end of the first translation driving member 231. In some embodiments, a lightening hole 2341 may be formed in a middle of the right-angle trapezoidal plate 234. The lightening hole 2341 is of a long strip shape, and extends in a direction parallel to the oblique leg of the right-angle trapezoidal shape. In this way, providing the lightening hole 2341 can reduce weight, decrease load, save material and so on.

In some embodiments, with reference to FIG. 4 and FIG. 12, there may be a plurality of the right-angle trapezoidal plates 234 which are arranged in parallel. In this way, a firmness of the connection between the first translation driving member 231 and the second translation driving member 232 can be improved. In some embodiments, the plurality of right-angle trapezoidal plates 234 are connected to each other through a second connection plate 235. The lower bases of the plurality of right-angle trapezoidal plates 234 are connected to the second connection plate 235. In this way, a firm connection of the right-angle trapezoidal plates 234 between the first translation driving member 231 and the second translation driving member 232 can be achieved. The second connection plate 235 is connected to the driving end 2311 of the first translation driving member by means of a fastener.

Furthermore, with reference to FIG. 4 and FIG. 12, in some embodiments, the support 233 is a V-shaped block. The V-shaped block is widely used in inspection, marking and positioning for a shaft component with high precision as well as in clamping during machining, serving as an important auxiliary tool in platform measurement. The V-shaped block is mainly used to support a cylindrical workpiece such as a shaft, a tube, a sleeve and so on. The use of the V-shaped block for supporting the second end of the insulator 1 may achieve a more accurate positioning of the insulator 1.

Obviously, above embodiments are merely examples made for clear explanation and are not limitations to implementations. For those skilled in the art, other different variations or modifications can be made on the basis of above description. All the implementations are not listed exhaustively in the present disclosure. Obvious variations or modifications derived from the present disclosure still fall within the scope of protection of the present disclosure.

1. A device under irradiation beam, configured to secure an insulator to allow the insulator to be irradiated by an irradiation source, the device under irradiation beam comprising:
a bracket;
a rotary clamp configured to clamp a first end of the insulator, the rotary clamp being rotatably connected to the bracket, an axis of rotation of the rotary clamp with respect to the bracket coinciding with an axis of the insulator when the insulator is clamped by the rotary clamp; and
a supporting member arranged on the bracket and configured to support a second end of the insulator.

2. The device under irradiation beam according to claim 1, wherein the bracket comprises:
a bottom frame on which the supporting member is arranged; and
a rotary frame which is movably connected to the bottom frame, and is rotatable with respect to the bottom frame to adjust an angle between the rotary frame and the bottom frame, when the device under irradiation beam is located at a predetermined position, the irradiation source and the device under irradiation beam are arranged in a first direction, there being an angle between an axis of rotation of the rotary frame with respect to the bottom frame and the first direction, the rotary clamp being rotatably connected to the rotary frame, there being an angle between an axis of rotation of the rotary clamp with respect to the rotary frame and the axis of rotation of the rotary frame with respect to the bottom frame.

3. The device under irradiation beam according to claim 2, wherein the bottom frame comprises:
a bottom frame body on which the supporting member is arranged; and
a supporting plate secured to the bottom frame body, the supporting plate being provided with a first slot, the rotary frame comprising a rotary frame body and a rotary shaft which is at least partly located within the first slot, the rotary shaft being rotatable with respect to the first slot around an axis, there being an angle between the axis of the rotary shaft and the first direction, the rotary shaft being secured to the rotary frame body, the rotary clamp being rotatably connected to the rotary frame body, there being an angle between an axis of rotation of the rotary clamp with respect to the rotary frame body and the axis of the rotary shaft.

4. The device under irradiation beam according to claim 3, wherein the first slot passes through two opposite sidewalls of the supporting plate, the device under irradiation beam further comprising a locking member which extends through two opposite sidewalls of the first slot, the locking member being configured to adjust a spacing between the two opposite sidewalls of the first slot to clamp the rotary shaft by the two opposite sidewalls of the first slot or release the rotary shaft from the two opposite sidewalls of the first slot.

5. The device under irradiation beam according to claim 3, wherein there is an angle between the axis of the rotary shaft and an extending direction of the first slot, an inner wall of the first slot being provided with a rotary shaft groove cooperating with the rotary shaft.

6. The device under irradiation beam according to claim 5, wherein the supporting plate is provided with scales along a circumference of the rotary shaft groove.

7. The device under irradiation beam according to claim 2, wherein the device under irradiation beam further comprises a driving member secured to the rotary frame, a driving end of the driving member being rotatably connected to the rotary clamp, the driving member being configured to drive the rotary clamp to rotate with respect to the bracket.

8. The device under irradiation beam according to claim 7, wherein the rotary frame has a through hole, the driving end of the driving member extends through the through hole, and the driving end of the driving member is connected with the rotary clamp.

9. The device under irradiation beam according to claim 7, wherein the device under irradiation beam further comprises a first shielding shell secured to the rotary frame, a cavity with a first opening being formed within the first shielding shell, the through hole being in communication with the cavity through the first opening, the driving member being located within the cavity, the driving end of the driving member extending into the through hole through the first opening.

10. The device under irradiation beam according to claim 7, wherein the bracket comprises a supporting frame and a shielding plate secured to each other, the shielding plate being perpendicular to the first direction, the device under irradiation beam further comprising a driving member controller electrically connected to the driving member, the driving member being arranged on a side of the shielding plate adjacent to the irradiation source, the driving member controller being arranged on a side of the shielding plate away from the irradiation source.

11. The device under irradiation beam according to claim 10, wherein the device under irradiation beam further comprises a second shielding shell arranged on the side of the shielding plate away from the irradiation source, an accommodation cavity being formed within the second shielding shell, the driving member controller being arranged within the accommodation cavity.

12. The device under irradiation beam according to claim 2, wherein the supporting member comprises:
a first translation driving member arranged on the bracket;
a second translation driving member secured to a driving end of the first translation driving member, the first translation driving member being configured to drive the second translation driving member to move in a second direction; and
a support configured to support the second end of the insulator, the support being secured to a driving end of the second translation driving member, the second translation driving member being configured to drive the supporting member to move in a third direction;
there is an angle between the second direction and the third direction, a plane defined by the second direction and the third direction being perpendicular to the axis of rotation of the rotary frame with respect to the bottom frame.

13. An irradiation production line comprising:
at least one device under irradiation beam;
an irradiation chamber with an inlet and an outlet, an irradiation source being arranged within the irradiation chamber, the device under irradiation beam being arranged within the irradiation chamber; and
a conveying member configured to drive the device under irradiation beam to move from the inlet towards the outlet, during a travel of the device under irradiation beam, the device under irradiation beam being located at a predetermined position when the device under irradiation beam is at a minimum distance from the irradiation source,
wherein the device under irradiation beam is configured to secure an insulator to allow the insulator to be irradiated by the irradiation source, and the device under irradiation beam comprises:
a bracket;
a rotary clamp configured to clamp a first end of the insulator, the rotary clamp being rotatably connected to the bracket, an axis of rotation of the rotary clamp with respect to the bracket coinciding with an axis of the insulator when the insulator is clamped by the rotary clamp; and
a supporting member arranged on the bracket and configured to support a second end of the insulator.
